(19) United States
(12) Patent Application Publication
(10) Pub. No.: US 2007/0262945 A1
(43) Pub. Date: Nov. 15, 2007

(54) METHOD AND APPARATUS FOR DRIVING DISPLAY DATA HAVING A MULTIPLEXED STRUCTURE OF SEVERAL STEPS

(76) Inventors: Jeong-seok CHAE, Suwon-si (KR); Jeong-su KANG, Suwon-si (KR); Jae-sung KANG, Suwon-si (KR)

Correspondence Address: F. CHAU & ASSOCIATES, LLC, 130 WOODBURY ROAD, WOODBURY, NY, 11797, US

(21) Appl. No.: 11/678,224

(22) Filed: Feb. 23, 2007

(30) Foreign Application Priority Data
Feb. 24, 2006 (KR) 10-2006-0018418

(51) Int. Cl. G09G 3/36

(52) U.S. Cl. 345/100

(57) ABSTRACT

An apparatus for and method of driving display data having a multiplex structure of several steps, in which the display data driving apparatus includes a memory unit storing gradation data of M bits (where M is a natural number) for driving a plurality of pixels included in a display panel, M/N first multiplexer (where M/N is a natural number) first multiplexers receiving the M bit gradation data that is divided into gradation data of N bits (where N is a natural number), and multiplexing the N bit gradation data, a second multiplexer multiplexing the M/N bit gradation data that is output by the M/N first multiplexers, and a source driver circuit receiving the gradation data that is output by the second multiplexer and transmitting the received gradation data to the display panel.

### CROSS-REFERENCE TO RELATED PATENT APPLICATION

This application claims the benefit of Korean Patent Application on No. 10-2006-0018418, filed on Feb. 24, 2006, in the Korean Intellectual Property Office, the disclosure of which is incorporated herein in its entirety by reference.

### BACKGROUND OF THE INVENTION

1. Technical Field

The present disclosure relates to an apparatus and method for driving display data, and more particularly, to an apparatus and method for driving display data having a multiplex (MUX) structure of several steps.

2. Discussion of Related Art

FIG. 1 is a schematic block diagram of a conventional display apparatus 100 in which the display apparatus 100 comprises a display panel 150, a gate driver circuit 170, a source driver circuit 180, and a memory unit 110.

The display panel 150 comprises a plurality of liquid crystal cells (not shown). The plurality of liquid crystal cells are arranged horizontally by the number of channels, and arranged vertically by the number of lines. The gate driver circuit 170 activates liquid crystal cells arranged in a specific line. The memory unit 110 stores gradation data DATA. The memory unit 110 outputs the stored gradation data DATA to the source driver circuit 180 in the form of gradation voltages S1 through SN. The source driver circuit 180 outputs the gradation voltages S1 through SN to the liquid crystal cells activated by the gate driver circuit 170.

The memory unit 110 is generally used to output the gradation data DATA to the source driver circuit 180 using a time division method. In this case, if the size of the source driver circuit 180 increases, wiring between the memory unit 110 and the source driver circuit 180 becomes complicated and thus, the size of a chip in which the display apparatus 100 is formed is increased. Also, even if the wiring between the memory unit 110 and the source driver circuit 180 is simplified, the size of the source driver circuit 180 cannot be reduced.

Therefore, a method of simplifying the wiring between the memory unit 110 and the source driver circuit 180 and reducing the size of the source driver circuit 180 is required.

### SUMMARY OF THE INVENTION

Exemplary embodiments of the present invention provide an apparatus for driving display data having a MUX structure of several steps.

Exemplary embodiments of the present invention also provide a display data driving method of multiplexing gradation data several times.

According to an exemplary embodiment of the present invention there is provided a display data driving apparatus that includes a memory unit storing gradation data of M bits (M denotes a natural number) for driving a plurality of pixels including a display panel, M/N first multiplexers (MIN denotes a natural number) receiving the M bit gradation data that is divided into gradation data of N bits (N is a natural number), and multiplexing the N bit gradation data, a second multiplexer multiplexing the M/N bit gradation data that is output by the M/N first multiplexers, and a source driver circuit receiving the gradation data that is output by the second multiplexer and transmitting the received gradation data to the display panel.

### BRIEF DESCRIPTION OF THE DRAWINGS

Exemplary embodiments of the present invention will be understood in more detail from the following descriptions taken in conjunction with the attached drawings, in which.

FIG. 1 is a schematic block diagram of a conventional display apparatus;

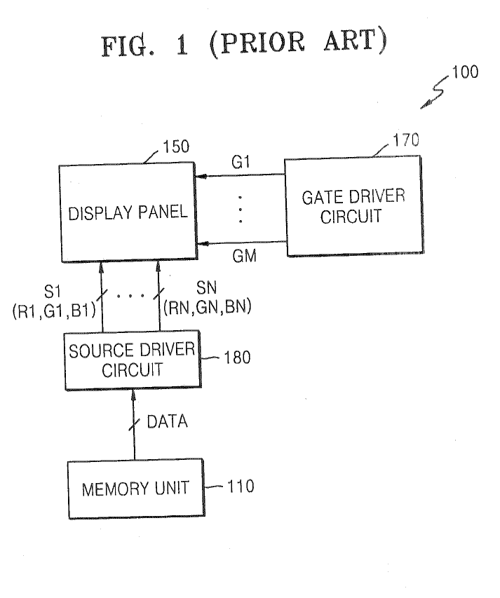

FIG. 2 is a block diagram of an apparatus for driving display data having a MUX structure of several steps according to an exemplary embodiment of the present invention;

FIG. 3 is a circuit diagram of multiplexers and a de-multiplexing unit used in the apparatus shown in FIG. 2;

FIG. 4 is a timing diagram of control signals that drive the multiplexers and the de-multiplexing unit illustrated in FIG. 3; and

FIG. 5 is a flowchart of a method of driving display data according to an exemplary embodiment of the present invention.

### DETAILED DESCRIPTION OF EXEMPLARY EMBODIMENTS

The filtering method and apparatus according to the exemplary embodiments of the present invention will now be described more fully with reference to the accompanying drawings, in which the exemplary embodiments of the invention are shown. The invention may, however, be embodied in many different forms and should not be construed as being limited to the exemplary embodiments set forth herein; rather, these exemplary embodiments are provided so that this disclosure will be thorough and complete. Like reference numerals in the drawings denote like elements.

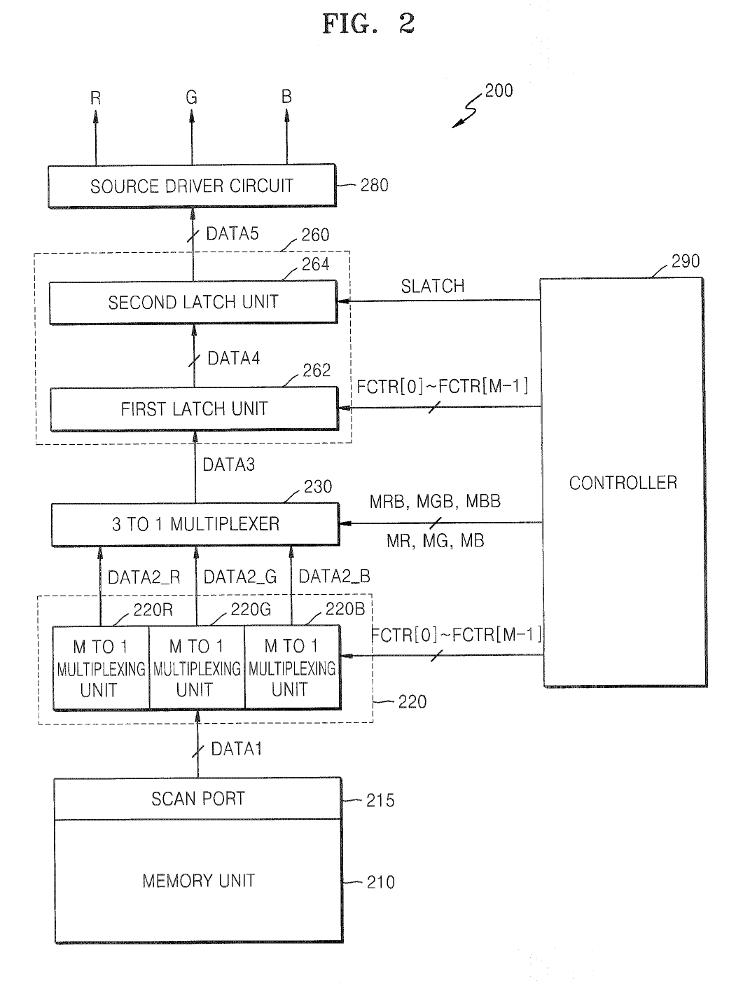

FIG. 2 is a block diagram of an apparatus 200 for driving display data having a MUX structure of several steps according to an exemplary embodiment of the present invention. Referring to FIG. 2, the apparatus 200 for driving display data comprises a memory unit 210, a first multiplexing unit 220, a second multiplexer 230, and a source driver circuit 280.

An image forming a pixel is expressed as gradation data DATA1 of M bits (M denotes a natural number). Also, the M bit gradation data DATA1 includes red (R) N bit gradation data, green (G) N bit gradation data, and blue (B) N bit gradation data.

The memory unit 210 stores the M bit gradation data DATA1 that drives a plurality of pixels included in a display panel (not shown). The memory unit 210 transfers the M bit gradation data DATA1 to the first multiplexing unit 220 through a scan port 215.

The first multiplexing unit 220 comprises a plurality of first multiplexers 220R, 220G and 220B. Each of the first multiplexers 220R 220G, and 220B receives the M bit gradation data DATA1 that is divided into N bits and multiplexes the received N bit gradation data DATA1. The number of the first multiplexers 220R 220G, and 220B included in the first multiplexing unit 220 is M/N.

The first multiplexing unit 220 may include an R multiplexer 220R, a G multiplexer 220G, and a B multiplexer 220B. In terms of multiplexing the M bit gradation data DATA, the R multiplexer 220R multiplexes the R gradation data, the G multiplexer 220G multiplexes the G gradation data, and the B multiplexer 220B multiplexes the B gradation data.

The second multiplexer 230 multiplexes M/N bit gradation data DATA2_R, DATA2_G, and DATA2_B output by the first multiplexers 220R, 220G, and 220B, respectively, and outputs them as DATA3. The source driver circuit 280 receives gradation data DATA3 output by the second multiplexer 230 through an optional de-multiplexing unit 250 as DATA5, and transmits the gradation data DATA5 to the display panel (not shown) as RGB data.

Each of the first multiplexers 220R, 220G, and 220B can receive the gradation data DATA1 of N bits and sequentially output the received N bit gradation data DATA1 one bit at a time as DATA2_R, DATA2_G and DATA2_B, respectively. The second multiplexer 230 can receive the M/N bit gradation data DATA2_R, DATA2_G, and DATA2_B and outputs gradation data one bit at a time as DATA3. The second multiplexer 230 can sequentially output the M bit gradation data DATA2_R, DATA2_G, and DATA2_B one bit at a time, which is received from the M/IN number of the first multiplexers 220R, 220G, and 220B respectively. More specifically, the second multiplexer 230 sequentially outputs the N bit gradation data one bit at a time, which is received from one of the first multiplexers 220R, 220G, and 220B, and then sequentially outputs the N bit gradation data DATA2 one bit at a time, which is received from another of the first multiplexers 220R, 220G and 220B. For example, the second multiplexer 230 receives first bits of gradation data from the first multiplexers 220R, 220G and 220B and outputs first bit of gradation data of the R multiplexer 220R, and then receives second bits of gradation data from the first multiplexers 220R, 220G and 220B and outputs second bits of the gradation data of the R multiplexer 220R. In the same manner, the second multiplexer 230 outputs the alt of the bits of gradation data of the R multiplexer 220R and then outputs all of the gradation data of the other first multiplexers 220G and 220B in sequence.

That is, the first multiplexers 220R, 220G and 220B and the second multiplexer 230 receive gradation data of multiple bits and output the received gradation data using the time division method, sequentially one bit at a time.

The apparatus 200 for driving display data may include the optional de-multiplexing unit 260. The de-multiplexing unit 260 de-multiplexes the N bit gradation data DATA3 output by the second multiplexer 230 and outputs the de-multiplexed gradation data as DATA5 to the source driver circuit 280.

The de-multiplexing unit 260 comprises a first latch unit 262 and a second latch unit 264. The first latch unit 262 sequentially receives the N bit gradation data DATA3 of N bits one bit at a time, which is output by the second multiplexer 230, and latches the received N bit gradation data DATA3. Then, the first latch unit 262 outputs the latched N bit gradation data DATA3 N bits at a time. The second latch unit 264 transfers the N bit gradation data DATA4 output by the first latch unit 263 to the source driver circuit 280. Operation of the controller will be described hereinbelow.

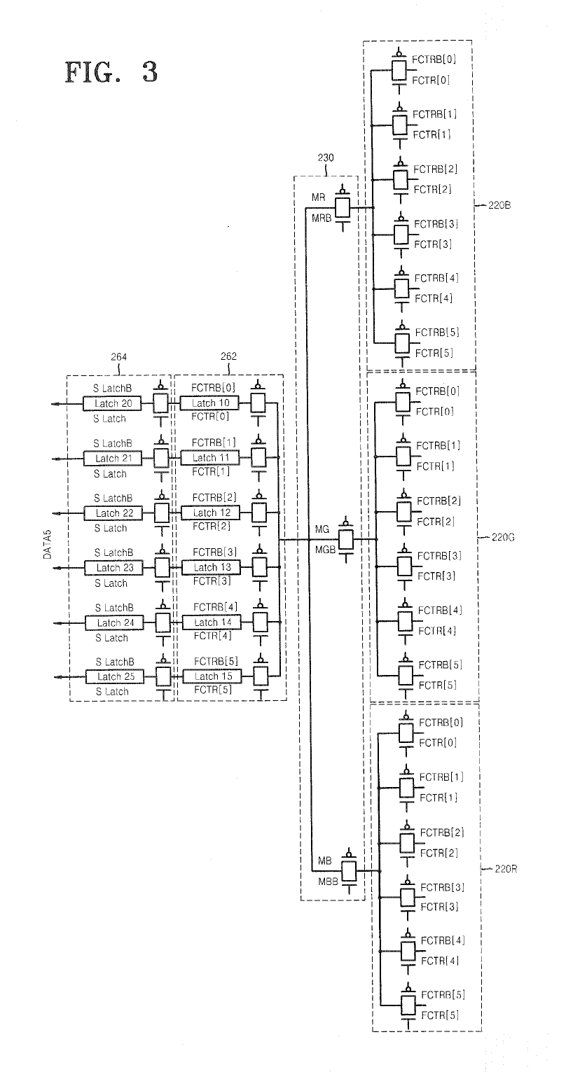

FIG. 3 is a circuit diagram of the first multiplexers 220R, 220G, and 220B, the second multiplexers 230, and the de-multiplexing unit that are shown in FIG. 2. An image forming a pixel is embodied using gradation data DATA1 of 18 bits. The 18 bit gradation data DATA1 includes R gradation data of 6 bits, G gradation data of 6 bits: and B gradation data of 6 bits.

Referring to FIG. 3: the first multiplexing unit, shown at 220 in FIG. 2, can comprise the R multiplexer 220R, the G multiplexer 220G, and the B multiplexer 220B. The R multiplexer 220R, the G multiplexer 220G and the B multiplexer 220B can include a plurality of switches. Each of the switches is turned on/off n response to first selection signals FCTR[0] through FCTR[5] from the controller 290 shown in FIG. 2, so that the 18 bit gradation data DATA1 is time-divided and transferred to the second multiplexer 230.

The second multiplexer 230 can also comprise a plurality of switches. Each of the switches is turned on/off in response to second selection signals MR, MRB, MG, MGB, MB, and MBB from the controller 290.

The first latch unit 262 can comprise N number of first latches, Latch10 through Latch15. The second latch unit 264 can comprise N number of second latches, Latch20 through Latch25. The first latches, Latch10 through Latch15, latch the 18 bit gradation data DATA1 in response to the first selection signals FCTR[0] through FCTR[5] from the controller 290. The second latches, Latch20 through Latch25, latch the 18 bit gradation data DATA1 in response to a latch control signal SLATCH from the controller 290 and output the latched 18 bit gradation data DATA5.

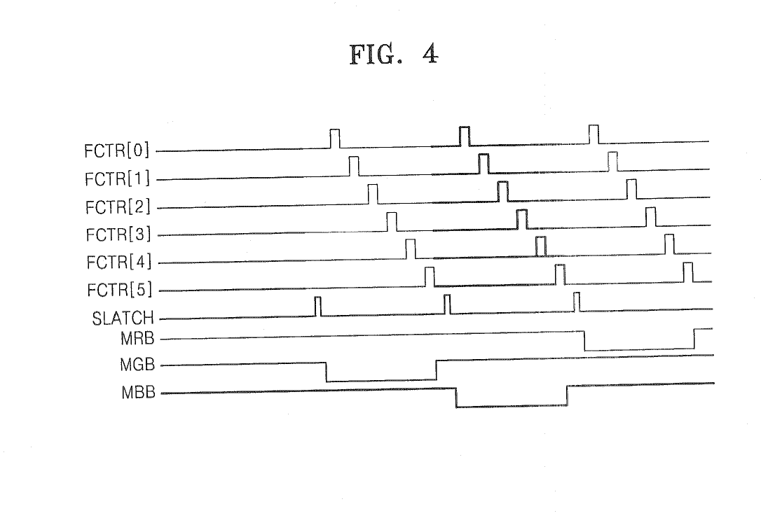

FIG. 4 is a timing diagram of control signals that drive the first multiplexers 220R, 220G, and 220B, the second multiplexer 230, and the de-multiplexing unit 260 illustrated in FIG. 3. The operation of the first multiplexers 220R, 220G, and 220B, the second multiplex 230, and the do-multiplexing unit 260 will now be described with reference to FIGS. 3 and 4.

Second inversion selection signals MRB, MOB, and MBB, and their complements MR, MG, and MB (not shown), are activated in order of logic low levels. In an activation section, the first selection signals FCTR[0] through FCTR[5] are activated in order of logic high levels.

The switches of the R multiplexer 220R, the G multiplexer 220G, and the B multiplexer 220B are sequentially turned on in response to the sequentially activated first selection signals FCTR[0] through FCTR[5]. More specifically, if the first selection signal FCTR[0] is activated, one of the switches of the R multiplexer 220R, one of the switches of the G multiplexer 220G, and one of the switches of the B multiplexer 220B is turned on, so that the R gradation data of 1 bit, the G gradation data of 1 bit, and the B gradation data of 1 bit are transferred to the second multiplexer 230. Then, the first selection signals FCTR[1] through FCTR[5] are activated sequentially. Accordingly, the other bits of R gradation data, the other bits of G gradation data, and the other bits of B gradation data are transferred to the second multiplexer 230. That is, the 6 bit R gradation data, the 6 bit G gradation data, and the 6 bit B gradation data are transferred to the second multiplexer 230 one bit at a time over six operations.

The second multiplexer 230 outputs one of the R gradation data, the G gradation data, and the B gradation data corresponding to the activated second inversion selection signal among second inversion selection signals MRB, MOB, and MBB. More specifically, among the three switches included in the second multiplexer 230, a switch corresponding to an activated second inversion selection signal is turned on. For example, in the section of FIG. 4 where the second inversion selection signal MBB is activated as indicated by a bold line, a switch, from among the three switches included in the second multiplexer 230, corresponding to the B gradation data is turned on.

As described above, the 6 bit R gradation data, the 6 bit G gradation data, and the 6 bit B gradation data are transferred to the second multiplexer 230 one bit at a time over six operations. Therefore, the second multiplexer 230 receives the first bit of the R gradation data, the first bit of the G gradation data, and the first bit of the B gradation data a bit at a time, and sequentially outputs the first bit of the B gradation data. Then, the second multiplexer 230 receives the second bit of the R gradation data, the second bit of the G gradation data, and the second bit of the B gradation data a bit at a time, and sequentially outputs the second bit of the B gradation data. Ultimately, the second multiplexer 230 receives the sixth bit of the R gradation data, the sixth bit of the G gradation data, and the sixth bit of the B gradation data a bit at a time, and sequentially outputs the sixth bit of the B gradation data.

The first latch unit 262 sequentially receives the 6 bit B gradation data one bit at a time. Then, the switches of the first latch unit 262 are sequentially turned on in response to the sequentially activated first selection signals FCTR[0] through FCTR[5] from the controller 290, so that the received 6 bit B gradation data is sequentially stored in the corresponding first latches Latch10 through Latch15.

The switches of the second latch unit 264 are simultaneously turned on in response to the latch control signal SLATCH from the controller 290. Therefore, the 6 bit B gradation data is simultaneously latched by the second latches Latch20 through Latch25 and simultaneously output to the source driver circuit 280 as DATA5. The latch control signal SLATCH is activated after the first selection signals FCTR[0] through FCTR[5] and the second selection signals MR, MG, and MB and MRB, MGB, and MBB.

The apparatus 200 for driving display data of the exemplary embodiment comprises a serially connected multiplexer structure of two steps. The apparatus 200 for driving display data can, however, comprise a serially connected multiplexer structure of more than two steps.

The apparatus 200 for driving display data comprising the serially connected multiplexer structure of several steps can reduce the number of wires that transmit gradation data between the memory unit 210 and the source driver circuit 280.

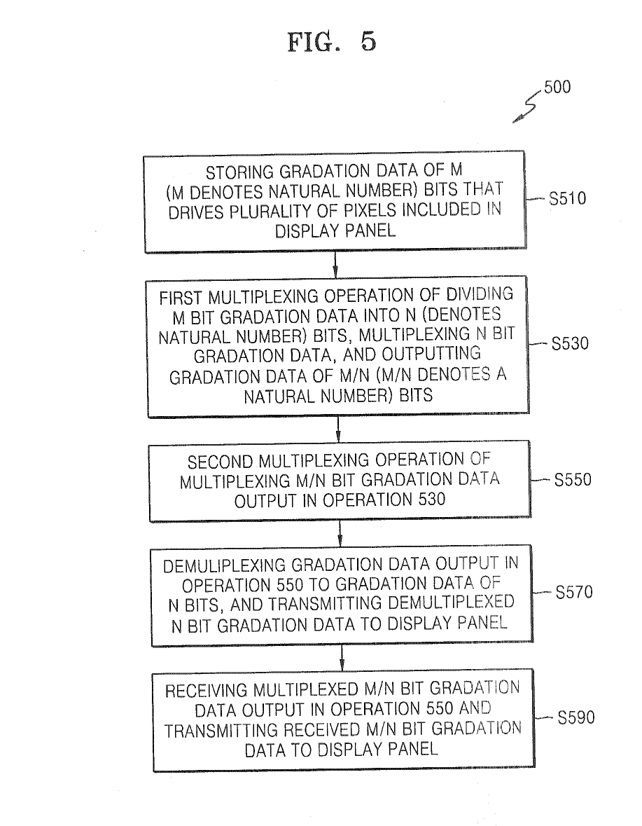

FIG. 5 is a flowchart of a method 500 of driving display data according to an exemplary embodiment of the present invention. Referring to FIG. 5, the method 500 of driving display data of the exemplary embodiment comprises storing gradation data of M bits (M denotes a natural number) that drives a plurality of pixels included in a display panel (Operation 510), a first multiplexing operation of dividing the M bit gradation data into N bits (denotes a natural number), multiplexing the N bit gradation data output in Operation 530, and outputting the gradation data of M/N bits (M/N denotes a natural number) (Operation 530), second multiplexing operation of multiplexing the M/N bit gradation data (Operation 550), and receiving the multiplexed M/N bit gradation data output in Operation 550 and transmitting the received MIN bit gradation data to the display panel (Operation 590).

The method 500 of driving display data of the current embodiment can further comprise demultiplexing the MIN bit gradation data output in Operation 550 to N bit gradation data, and transmitting the demultiplexed N bit gradation data to the display panel (Operation 570).

The method 500 of driving display data of the exemplary embodiment utilizes the same technical idea as the apparatus 200 of that exemplary embodiment for driving display data, and corresponds to the operation of the apparatus 200 of driving display data. Therefore, since the method of driving display data can be easily understood from the aforementioned description by those of ordinary skill in the art, its detailed description is omitted.

According to exemplary embodiments of the present invention, an apparatus for driving display data having a MUX structure of several steps can efficiently arrange wires between a memory unit and a source driver circuit, and reduce an area between the memory unit and a source driver circuit.

While the present invention has been particularly shown and described with reference to exemplary embodiments thereof it will be understood by those of ordinary skill in the art that various changes in form and details may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A display data driving apparatus comprising:
a memory unit storing gradation data of M bits (where M is a natural number) for driving a plurality of pixels included in a display panel;
a plurality of MIN first multiplexers (where MIN is a natural number) receiving the M bit gradation data which is divided into gradation data of N bits (where N is a natural number), and multiplexing the gradation data of N bits;
a second multiplexer multiplexing the M/N bit gradation data that is output by the M/N first multiplexers, and
a source driver circuit receiving the gradation data that is output by the second multiplexer and transmitting the received gradation data to the display panel.

2. The display data driving apparatus of claim 1 wherein the plurality of MIN first multiplexers comprises;
an R multiplexer multiplexing R gradation data among the M bit gradation data;
a G multiplexer multiplexing G gradation data among the M bit gradation data; and
a B multiplexer multiplexing B gradation data among the M bit gradation data.

3. The display data driving apparatus of claim 1 wherein each of the plurality of MIN first multiplexers receives the N bit gradation data and sequentially outputs the received N bit gradation data one bit at a time, and
the second multiplexer receives the M/N bit gradation data and sequentially outputs the received gradation data of M/N bits one bit at a time.

4. The display data driving apparatus of claim 3, wherein the second multiplexer sequentially outputs the M bit gradation data one bit at a time, and the M bit gradation data is received from the plurality of M/N first multiplexers N bits at a time.

5. The display data driving apparatus of claim 3, wherein the second multiplexer sequentially outputs the N bit gradation data, which is received from one of the plurality of M/N first multiplexers, one bit at a time and sequentially outputs the N bit gradation data, which is received from the others of the plurality of M/N first multiplexers, one bit at a time.

6. The display data driving apparatus of claim 1, further comprising: a de-multiplexing unit de-multiplexing the N bit gradation data output by the second multiplexer and outputting the de-multiplexed N bit gradation data to the source driver circuit.

7. The display data driving apparatus of claim 6, wherein the de-multiplexing unit sequentially receives the gradation data that is output by the second multiplexer one bit at a time and outputs the N bit gradation data simultaneously.

8. The display data driving apparatus of claim 6, wherein the de-multiplexing unit comprises, a first latch unit including a plurality of N first latches latching the gradation data output by the second multiplexer and outputting the latched gradation data simultaneously.

9. The display data driving apparatus of claim 8, wherein each of the plurality of M/N first multiplexers and the second latch unit operate in response to an identical control signal.

10. The display data driving apparatus of claim 8, wherein the de-multiplexing unit further comprises: a second latch unit including a plurality of N second latches transferring the N bit gradation data output by the plurality of N first latches to the source driver circuit.

11. A display data driving apparatus comprising:
a memory unit storing gradation data of M bits (where M is a natural number) for driving a plurality of pixels included in a display panel;
first through L multiplexing units (where L is a natural number) each comprising at least one multiplexer; and
a source driver circuit transmitting the M bit gradation data to the display panel,
wherein multiplexers of the first multiplexing unit receive the M bit gradation data, which is divided into pieces of gradation data, and multiplex the received gradation data;
multiplexers of an i^{th} multiplexing unit (where i is a natural number from 2 to L) receive gradation data that is output by an i−1 multiplexer and divided into pieces of gradation data, and multiplex the received gradation data, and
the source driver circuit receives gradation data that is output by multiplexers of the L multiplexing unit and transmits the received gradation data to the display panel.

12. The display data driving apparatus of claim 11, wherein the first multiplexing unit comprises.
an R multiplexer multiplexing R gradation data from among the M bit gradation data;
a G multiplexer multiplexing G gradation data from among the M bit gradation data; and
a B multiplexer multiplexing B gradation data from among the M bit gradation data.

13. The display data driving apparatus of claim 11 further comprising: a de-multiplexing unit de-multiplexing the gradation data output by the multiplexers of the L multiplexing unit and outputting the de-multiplexed gradation data to the source driver circuit.

14. The display data driving apparatus of claim 13, wherein the de-multiplexing unit comprises: N latches latching the gradation data output by the multiplexers of the L multiplexing unit and outputting the latched gradation data simultaneously.

15. A display data driving method comprising:
storing gradation data of M bits (where M is a natural number) for driving a plurality of pixels included in a display panel;
a first multiplexing operation of dividing the M bit gradation data into gradation data of N bits (where N is a natural number), and multiplexing the N bit gradation data;
a second multiplexing operation of multiplexing MIN bit gradation data that is output in the first multiplexing operation; and
receiving the gradation data that is output in the second multiplexing operation and transmitting the received gradation data to the display panel.

16. The display data driving method of claim 15, wherein the first multiplexing operation comprises:
an R multiplexing operation of multiplexing R gradation data from among the M bit gradation data;
a G multiplexing operation of multiplexing G gradation data from among the M bit gradation data; and
a B multiplexing operation of multiplexing B gradation data from among the M bit gradation data.

17. The display data driving method of claim 15, further comprising: a de-multiplexing operation of de-multiplexing the N bit gradation data that is output in the second multiplexing operation and transmitting the de-multiplexed N bit gradation data to the display panel.

18. The display data driving method of claim 17, wherein the de-multiplexing operation comprises sequentially receiving the gradation data that is output in the second multiplexing operation, latching the received gradation data, and outputting the N bit gradation data simultaneously.

19. A display data driving method comprising:
storing gradation data of M bits (where M is a natural number) for driving a plurality of pixels included in a display panel;
performing first through L multiplexing operations (where L denotes is a natural number) of sequentially multiplexing the M bit gradation data; and
transmitting the multiplexed M bit gradation data to the display panel,
wherein the first multiplexing operation comprises receiving the M bit gradation data, which is divided into pieces of gradation data, and multiplexing the received gradation data,
wherein the first through L multiplexing operations comprise receiving gradation data, which is output in the i−1 multiplexing operations and divided into pieces of gradation data, and multiplexing the received gradation data, and
wherein gradation data that is output in the L multiplexing operation is received and the received gradation data is transmitted to the display panel.
